(19) United States
(12) Patent Application Publication
(10) Pub. No.: US 2003/0063087 A1
(43) Pub. Date: Apr. 3, 2003

(54) Variable-formatable width buffer and method of use

(76) Inventors: Peter L. Doyle, El Dorado Hills, CA (US); William B. Sadler, Folsom, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/964,765

(22) Filed: Sep. 28, 2001

(51) Int. Cl. G06T 15/40

(52) U.S. Cl. 345/422

(57) ABSTRACT

A method is provided for performing a depth test for an image in a graphics system. This may include determining a format of a depth buffer device and storing a value associated with a pixel of the image in the depth buffer device based on the determined format of the depth buffer device. In the depth test, a value associated with a current pixel may be compared to the value stored in the depth buffer device in the determined format.

### FIELD

The present invention is directed to a computer graphics architecture. More particularly, the present invention is directed to use of a variable-formatable depth buffer.

### BACKGROUND

A typical computer system includes a processor subsystem of one or more microprocessors such as Intel® i386, i486, Celeron™ or Pentium® processors, a memory subsystem, one or more chipsets (or chips) provided to support different types of host processors for different platforms such as desktops, personal computers (PC), servers, workstations and mobile platforms, and to provide an interface with a plurality of input/output (I/O) devices including, for example, keyboards, input devices, disk controllers, and serial and parallel ports to printers, scanners and display devices. Chipsets may integrate a large amount of I/O bus interface circuitry and other circuitry onto only a few chips. Examples of such chipsets may include Intel® 430, 440 and 450 series chipsets, and more recently Intel® 810 and 8XX series chipsets. These chipsets may implement, for example, the I/O bus interface circuitry, direct memory access (DMA) controller, graphics controller, graphics memory controller, and other additional functionality such as graphics visual and texturing enhancements, data buffering, and integrated power management functions.

In traditional three-dimensional (3D) graphics systems, 3D images may be generated for representation on a two-dimensional (2D) display monitor. The 2D representation may be provided by defining a 3D model space and assigning sections of the 3D model space to pixels for a visual display on the display monitor. Each pixel may display the combined visual effects such as color, shade and transparency defined on an image.

A depth buffer may be employed to provide hidden surface removal. More specifically, a depth value may be associated for each pixel in the image. The depth values of pixels of objects subsequently drawn are compared to the corresponding pixel's value in the depth buffer, and the result of the comparison may be used to either reject the new pixel or to accept the new pixel (and thereby store it's depth value in the depth buffer). Typically, new pixels with smaller (i.e., closer) depth values are accepted while new pixels with larger (i.e., farther) depth values are discarded since they are obscured by the current pixel at that location. The more accurate the depth buffer, the more accurate the graphics device and the displayed images. It is desirable to have a graphics device that operates with a more accurate and cost-effective depth buffer so as to provide better images.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 illustrates a block diagram of an example computer system having a graphics platform according to an example embodiment of the present invention;

FIG. 2 illustrates a block diagram of an example computer system having a graphics platform according to an example embodiment of the present invention;

FIG. 3 illustrates a block diagram of an example computer system having a host chipset for providing a graphics platform according to an example embodiment of the present invention;

FIG. 4 illustrates a functional diagram of an example graphics and memory controller hub (GMCH) according to an example embodiment of the present invention;

FIG. 5 is a block diagram of a 3D graphics rendering engine;

FIG. 6 is a graph illustrating values of Screen Z and W/Wfar based on an Eye Z value;

FIG. 7 is a block diagram of depth-buffering functional units within a 3D engine according to an example embodiment of the present invention;

FIGS. 8A-8C illustrate formatting of a 16-bit number within the depth buffer according to an example embodiment of the present invention; and

FIGS. 9A-9B illustrate formatting of a 32-bit number within the depth buffer according to an example embodiment of the present invention.

### DETAILED DESCRIPTION

In the following detailed description, like reference numerals and characters may be used to designate identical, corresponding or similar components in differing figure drawings. Arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the knowledge of one skilled in the art. Where specific details are set forth in order to describe example embodiments of the invention, it should be apparent to one skilled in the art that the invention can be practiced without, or with variation of, these specific details. Finally, it should be apparent that differing combinations of hard-wired circuitry and/or software instructions may be used to implement embodiments (or portions of embodiments) of the present invention. That is, embodiments of the present invention are not limited to any specific combination of hardware and/or software.

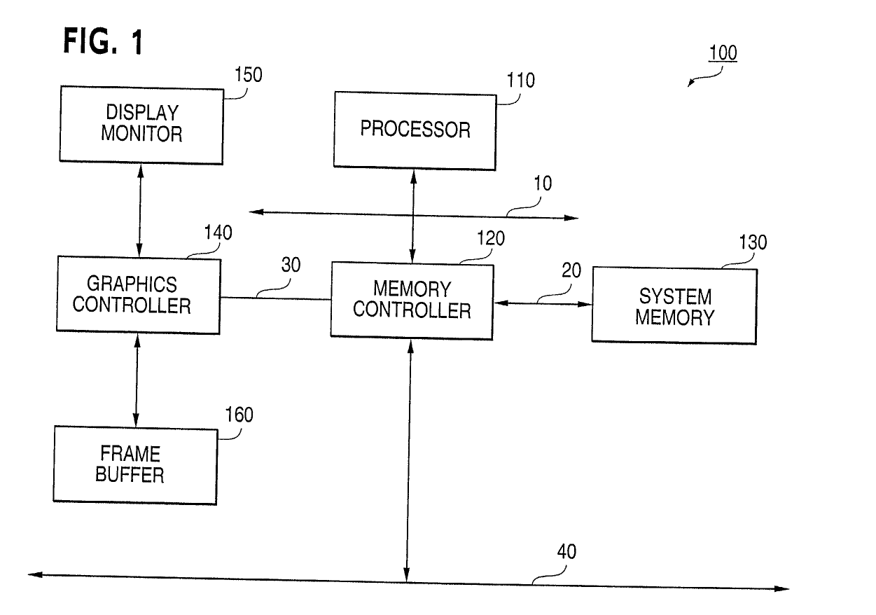

FIG. 1 illustrates an example computer system 100 having a graphics platform according to an example embodiment of the present invention. Other embodiments and configurations are also within the scope of the present invention. The computer system 100 (which can be a system commonly referred to as a personal computer or PC) may include one or more processors or processing units 110 such as Intel® i386, i486, Celeron™ or Pentium® processors, a memory controller 120 coupled to the processing unit 110 via a front side bus 10, a system memory 130 coupled to the memory controller 120 via a memory bus 20, and a graphics controller 140 coupled to the memory controller 120 via a graphics bus (e.g., Advanced Graphics Port “AGP” bus) 30,

Alternatively, the graphics controller 140 may also be configured to access the memory controller 120 via a peripheral bus such as a peripheral component interconnect (PCI) bus 40 if so desired. The PCI bus may be a high performance 32 or 64 bit synchronous bus with automatic configurability and multiplexed address, control and data lines as described in the latest version of “PCI Local Bus Specification, Revision 2.1” set forth by the PCI Special Interest Group (SIG) on Jun. 1, 1995 for added-on arrangements (e.g., expansion cards) with new video, networking, or disk memory storage capabilities. The graphics controller 140 may control a visual display of graphics and/or video images on a display monitor 150 (e.g., cathode ray tube, liquid crystal display and flat panel display). The display monitor 150 may be either an interlaced or progressive monitor, but typically is a progressive display device. A frame buffer 160 may be coupled to the graphics controller 140 for buffering the data from the graphics controller 140, the processing unit 110, or other devices within the computer system 100 for a visual display of video images on the display monitor 150.

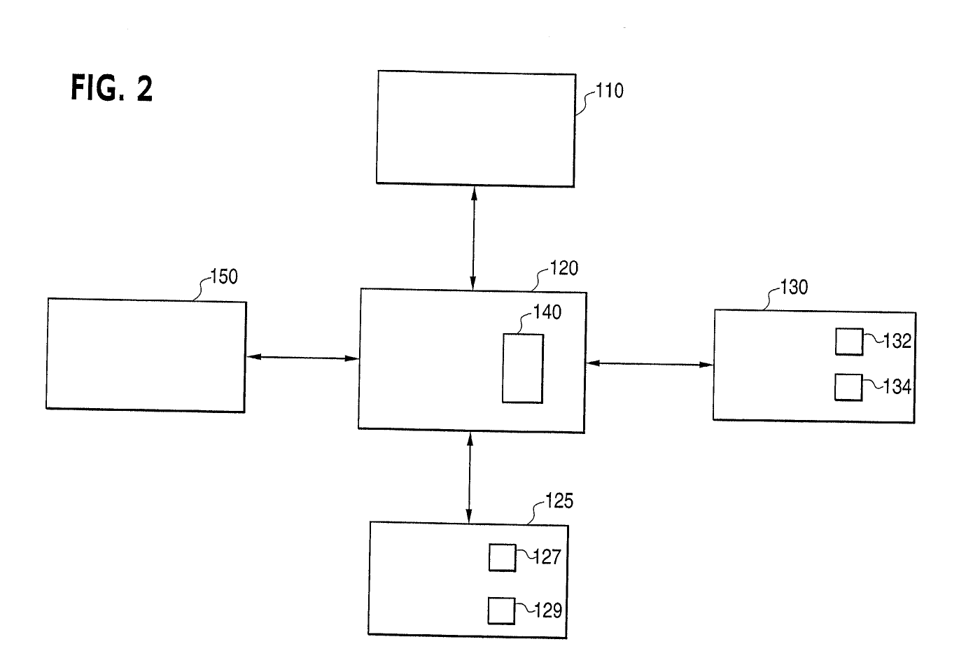

FIG. 2 illustrates a block diagram of a computer system having a graphics platform according to another example embodiment of the present invention. Other embodiments and configurations are also within the scope of the present invention. As shown in FIG. 2, the memory controller 120 and the graphics controller 140 may be integrated as a single graphics and memory controller hub (GMCH) including dedicated multi-media engines executing in parallel to deliver high performance 3D, 2D and motion compensation video capabilities, for example. The GMCH may be implemented as a PCI chip such as, for example, a PIIX4® chip and a PIIX6® chip manufactured by Intel Corporation. In addition, such a GMCH may also be implemented as part of a host chipset along with an I/O controller hub (ICH) and a firmware hub (FWH) as described, for example, in Intel® 810 and 8XX series chipsets.

In addition to showing the graphics controller 140 provided within the memory controller 120, FIG. 2 further shows the processor unit 110, the display monitor, the system memory 130 and a local memory 125 each coupled to the memory controller 120. The system memory 130 may include a depth buffer 132 and a color buffer 134. Similarly, the local memory 125 may also include a depth buffer 127 and a color buffer 129.

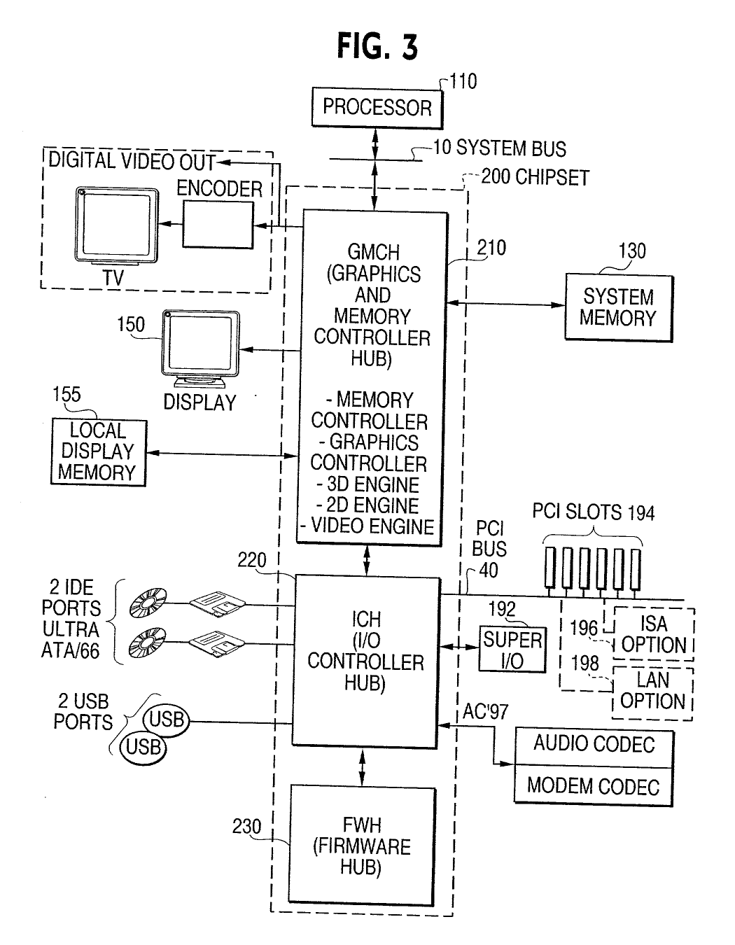

FIG. 3 illustrates an example computer system (such as the computer system 100) including such a host chipset 200 according to an example embodiment of the present invention. Other embodiments and configurations are also within the scope of the present invention. As shown in FIG. 3, the computer system may include essentially the same components shown in FIGS. 1 and 2, except for the host chipset 200 that provides a highly-integrated three-chip solution including a graphics and memory controller hub (GMCH) 210, an input/output (I/O) controller hub (ICH) 220 and a firmware hub (FWH) 230.

The GMCH 210 may provide graphics and video functions and interface one or more memory devices to the system bus 10. The GMCH 210 may include a memory controller as well as a graphics controller (which in turn may include a 3D engine, a 2D engine, and a video engine). The GMCH 210 may be interconnected to any of the system memory 130, a local display memory 155, a display monitor 150 (e.g., a computer monitor) and to a television (TV) via an encoder and a digital video output signal. The GMCH 120 may be, for example, an Intel® 82810 or 82810-DC100 chip. The GMCH 120 may also operate as a bridge or interface for communications or signals sent between the processor unit 110 and one or more I/O devices that may be coupled to the ICH 220.

The ICH 220 may interface one or more I/O devices to the GMCH 210. The FWH 230 may be coupled to the ICH 220 and provide firmware for additional system control. The ICH 220 may be, for example, an Intel® 82801 chip and the FWH 230 may be, for example, an Intel® 82802 chip.

The ICH 220 may be coupled to a variety of I/O devices and the like such as: a Peripheral Component Interconnect (PCI) bus 40 (PCI Local Bus Specification Revision 2.2) that may have one or more I/O devices coupled to PCI slots 194, an Industry Standard Architecture (ISA) bus option 196 and a local area network (LAN) option 198; a Super I/O chip 192 for connection to a mouse, keyboard and other peripheral devices (not shown); an audio coder/decoder (Codec) and modem Codec; a plurality of Universal Serial Bus (USB) ports (USB Specification, Revision 1.0); and a plurality of Ultra/66 AT Attachment (ATA) 2 ports (X3T9.2 948D specification; commonly also known as Integrated Drive Electronics (IDE) ports) for receiving one or more magnetic hard disk drives or other I/O devices.

The USB ports and IDE ports may be used to provide an interface to a hard disk drive (HDD) and compact disk read-only-memory (CD-ROM). I/O devices and a flash memory (e.g., EPROM) may also be coupled to the ICH of the host chipset for extensive I/O support and functionality. Those I/O devices may include, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers and scanners. The flash memory may be coupled to the ICH of the host chipset via a low pin count (LDC) bus. The flash memory may store a set of system basic input/output start up (BIOS) routines at startup of the computer system. The super I/O chip 192 may provide an interface with another group of I/O devices.

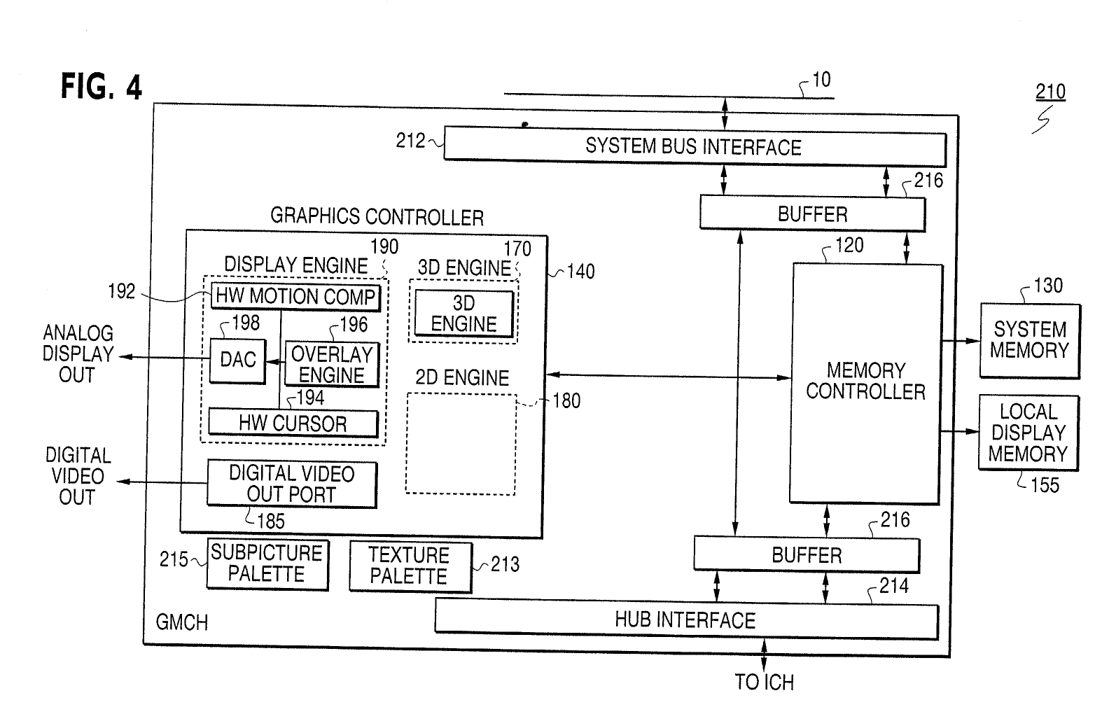

FIG. 4 illustrates a block diagram of the graphics and memory controller hub (GMCH) 210 according to an example embodiment of the present invention. Other embodiments and configurations are also within the scope of the present invention. The GMCH 210 may include the graphics controller 140 to provide graphics and video functions and the memory controller 120 to control and interface one or more memory devices via the system bus 20. The memory controller 120 may be coupled to the system bus 40 via a buffer 216 and a system bus interface 212. The memory controller 120 may also be coupled to the ICH 220 via a buffer 216 and a hub interface 214. In addition, the GMCH 210 may be coupled to the system memory 130 and, optionally, a local display memory 155 (also commonly referred to as video or graphics memory typically provided on a video card or video memory card). In a cost saving unified memory architecture (UMA), the local display memory 155 may reside in the computer system. In such an architecture, the system memory 130 may operate as both system memory and the local display memory.

The graphics controller 140 of the GMCH 210 may include a 3D rendering engine 170 for performing a variety of 3D graphics functions, including creating a rasterized 2D display image from representation of 3D objects, a 2D engine 180 for performing 2D functions, a display engine 190 for displaying video or graphics images, and a digital video output port 185 for outputting digital video signals and providing connection to traditional TVs or new space-saving digital flat panel displays.

The 3D rendering engine 170 may perform a variety of functions including perspective-correct texture mapping to deliver 3D graphics without annoying visual anomalies such as warping, bending or swimming; bilinear and anisotropic filtering to provide smoother and more realistic appearance 3D images; MIP mapping to reduce blockiness, texture map aliasing artifacts, and enhance image quality; Gouraud shading, alpha-blending, fogging and Z-buffering.

The display engine 190 may include a hardware motion compensation module 192 for performing motion compensation to improve video decode performance, a hardware cursor 194 for providing cursor patterns, an overlay engine 196 for merging either video data captured from a video source or data delivered from the 2D engine 180 with graphics data on the display monitor 150, and a digital-to-analog converter (DAC) 198 for converting digital video signals to analog video signals for a visual display on the display monitor 150. The hardware motion compensation module 192 may alternatively reside within the 3D engine 170 for purposes of simplicity.

A texture palette 213, also known as a color lookup table (CLUT), may be provided within the GMCH 210 to identify a subset from a larger range of colors. A small number of colors in the palette 213 allows fewer bits to be used to identify the color or intensity of each pixel. The colors for the textures are identified as indices to the texture palette 213. In addition, a subpicture palette 215 may separately be provided for color alpha-blending subpicture pixels for transparency. However, a single dual-purpose palette may be used as both a texture palette and a subpicture palette to save hardware and reduce costs. The alpha-blending of the subpicture with video is an operation typically associated with video processing, while texturing is typically associated with 3D processing.

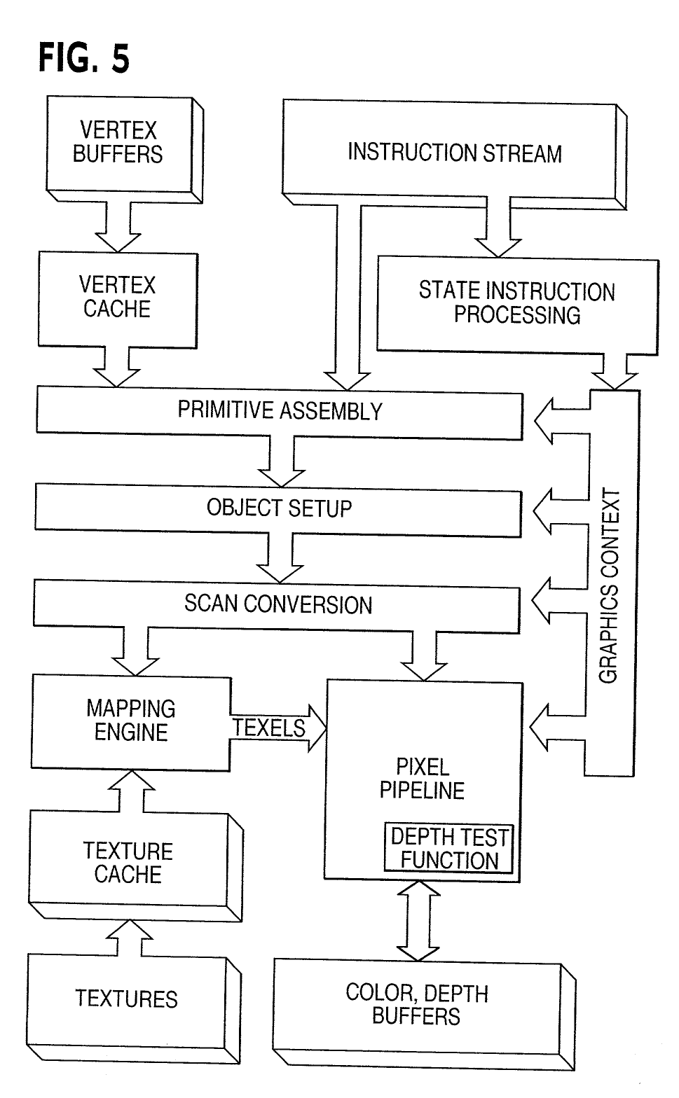

FIG. 5 is a high level block diagram of a 3D engine that may be provided within a graphics device (such as within the 3D engine 170 of FIG. 4). This diagram shows various features and functions that may be performed within the 3D rendering engine. The various buffers and/or caches (such as the vertex, the texture, the color and the depth) may be within the graphics device or may be provided in local memory. As shown in the diagram, a depth test function may be embedded within the 3D engine's pixel pipeline.

Stated briefly, the driver software may store an instruction stream in memory. The instruction stream may include of instructions that define graphical objects (known as primitive instructions) and instructions that affect how the graphical objects are rendered (known as state instructions). The 3D rendering engine may read the instruction stream from memory and execute the instructions as described below.

The 3D rendering engine may execute state instructions in a state instruction processing unit that may subsequently modify values in the graphics context. The values within the graphics context control the various subfunctions within the 3D rendering engine (e.g., texture mapping controls, color blending controls, depth test controls, etc.).

Primitive instructions may be processed by a pipelined arrangement of rendering functions. First the primitive assembly function collects all the information requried to define a graphical object. Parts of the definition of a graphical object are values associated with the vertices of the object. This information may be contained within the instruction stream or stored in vertex buffers in memory. When stored in vertex buffers, the vertex data may be temporarily held in a vertex cache to improve performance when the vertex data is reused.

Once the graphical object is defined by the primitive assembly function, it may be passed to the object setup function. The object setup function may compute values required by the subsequent scan conversion function. The scan conversion function may compute the mapping of the graphical object onto some set of discrete pixel locations contained within the color and depth buffers. The scan conversion function also computes values associated with each of the aforementioned pixel locations. The set of pixel locations and their associated values may then be passed to the mapping engine and pixel pipeline functions.

The mapping engine function may compute texture data associated with the set of pixel locations. Typically the texture data is computed using texture map information stored in memory. This texture map information may be temporarily stored in a texture cache to improve performance when texture map information is reused. The mapping engine passes the computed texture data (known as texels) associated with each of the sets of pixel locations to the pixel pipeline function.

The pixel pipeline function may use the information provided by the scan conversion and mapping engine functions to produce new pixel color and pixel depth values associated with each of the pixel locations contained within the graphical object. These new pixel color and pixel depth values may be combined with some set of pixel values stored within the color and depth buffers. The results of these combinations may be stored in the color and depth buffers.

As discussed above, computer graphics systems may employ a depth buffer to provide hidden surface removal. As is well known in the art, a depth buffer may contain depth values associated with each pixel in an image. The depth buffer may typically be cleared to an initial valve that represents the farthest possible depth valve. The depth values of pixels of objects subsequently drawn are compared to the corresponding pixel's value in the depth buffer, and the result of the comparison may be used to either reject the new pixel or to accept the new pixel (and thereby store it's depth value in the depth buffer). This may also be referred to as a depth test. Typically, new pixels with smaller (i.e., closer) depth values are accepted while new pixels with larger (i.e., farther) depth values are discarded since they are obscured by the current pixel at that location.

As is well known in the art, one coordinate system in which to perform the depth test is “eye space” (also known as “camera space”). The eye space is a three dimensional coordinate system that conceptually exists after a viewing transformation and before perspective transformation is performed as will be described below. In eye space, Eye Z is the distance along the Z axis from the eye to the object vertex.

In a typical 3D graphics pipeline, a projection process may be applied to objects in the three dimensional eye space in order to provide a mapping onto a two dimensional image plane. The projection process typically includes a perspective transformation that produces four dimensional “homogeneous” (X, Y, Z, W) object coordinates, followed by a “perspective divide” operation. The homogeneous W coordinate output from the perspective transformation is typically equal to Eye Z.

The perspective divide operation divides the homogeneous X, Y, and Z coordinates by the homogeneous W coordinate, thereby projecting object vertices onto a two-dimensional image plane defined by two-dimensional coordinates. These two-dimensional coordinates may be referred to as Screen X and Screen Y coordinates. The Z coordinate output from the perspective division is typically normalized to the range of [0,1] where 0.0 corresponds to a near clipping plane in eye space and 1.0 corresponds to a far clipping plane in eye space. This normalized value may be referred to as Screen Z. The Screen Z coordinate, combined with the Screen X and Screen Y coordinates, yields a three-dimensional coordinate system that may be referred to as “screen space”. Screen Z is typically also a function of the reciprocal of the homogeneous W term, which allows it to be linearly interpolated in screen space without introducing artifacts.

Under orthographic projections, the output Screen Z value may simply be a normalized version of Eye Z (i.e., it may be a linear mapping of Eye Z onto the range [0,1]). For orthographic projections or projections with only very slight perspective, Screen Z may be the only option for the depth test as the vertex homogeneous W coordinates are typically all very close to 1. Under orthographic projections, where the Screen Z value is typically a linear function (or nearly a linear function) of the Eye Z value, the depth test may be fairly accurate.

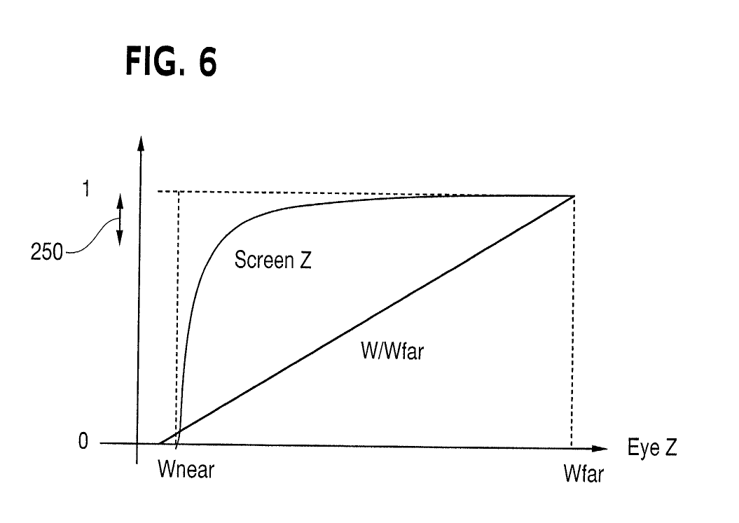

On the other hand, for perspective projections (such as in most computer games), the Screen Z value may not be ideal for the depth test. The perspective division (to allow linear interpolation of the comparison value) will typically introduce a non-linear mapping of the Eye Z coordinates. This may map most of the Eye Z range into a very small region of Screen Z as may be seen in the graph of FIG. 6. More specifically, FIG. 6 shows that most of the Eye Z range is mapped into the region labeled 250, which is close to 1.0.

The non-linearity of the Screen Z value may be controlled to some degree by defining the Eye Z range (i.e., the near to far region) to closely match the placement of the visible objects. This may better distribute objects within the Screen Z range. Use of an unnecessarily large Eye Z range may place the objects closer in the Screen Z range thereby exacerbating the problem introduced by the non-linear perspective division.

For perspective projections, one alternative to using the Screen Z value in the depth test is to use a Normalized W value. As discussed above, the W coordinate output from the perspective transformation is Eye Z, which may be used for the depth test. However, two problems may occur by using the Eye Z value for the depth test, namely: (1) that the Eye Z value is not normalized (i.e., it varies in the arbitrary Eye Z range) thereby making the hardware implementation more costly; and (2) the Eye Z value is not a function of the reciprocal of W and therefore can not be linearly interpolated across the primitive. The first problem may be overcome by normalizing the value by dividing by Wfar (i.e., the Eye Z value of the far clipping plane) to thereby yield W/Wfar (which is a positive fraction). Any negative W values may be removed by clipping and/or the perspective division. The second problem may be overcome by interpolating the inverse of the normalized W value (i.e., Wfar/W), which is a function of 1/W. This interpolated value may be subsequently re-inverted to yield the positive W/Wfar fraction used in the depth test and stored in the depth buffer. FIG. 6 shows the linear mapping of the W/Wfar value. This value therefore varies linearly between 0 and 1 unlike the Screen Z value in which most the coordinates are mapped to the region 250 close to 1.0.

Embodiments of the present invention may utilize a variable-formatable floating point number in the depth buffer so as to maximize the depth-value precision within the depth buffer. This may result in fewer artifacts and better resolution of the image on the display. It is desirable to maximize the number of fraction bits within the variable-formatable floating point number so as to have better resolution. This may be done by (a) eliminating use of the sign bit due to the normalized value, and (b) reducing the number of exponent bits within the floating point number and using those bits for fraction bits (rather than exponent bits and the sign bit). That is, certain bits may be better utilized as fraction bits rather than as exponent bits. Embodiments of the present invention may determine the proper use of those bits to result in better resolution on the display screen. That is, the use of bits within the depth buffer may be reallocated if the range of numbers that will be tested is known. Further, the depth buffer (having the variable-formatable floating point number) may store and test a W/Wfar value as compared with disadvantageous arrangements discussed above that may store and test a Z value or that may store and test a 1/W value. The W/Wfar value may be obtained by interpolating the Wfar/W value and subsequently determining the W/Wfar value by inversion,

Embodiments of the present invention may calculate the number of fraction/exponent bits in the variable-formatable floating point number based on a predetermined equation (or formula). In one embodiment, this equation may be based on the values (or ratio) of Wfar and Wnear, which are known to the software driver and may be needed for perspective mapping and clipping. The determination of the number of fraction bits may be done by the software driver provided within a processing unit (such as the processing unit 110). The number of fraction bits in the variable-formatable floating point number may be stored within a register (such as in the graphics controller 140 and communicated to the appropriate hardware such as the depth buffer). The depth test may include a comparison of the W/Wfar value of a new pixel with the W/Wfar value of the corresponding pixel already stored in the depth buffer. Because of the larger number of fraction bits used in the depth test according to example embodiments of the present invention, a better depth test may be performed and, as a result, the screen may display an image having better resolution and fewer artifacts. The variable format may be used to store the number within the depth buffer. When read, the stored valves may be reformatted to match the internal (full-precision) format used in the comparison.

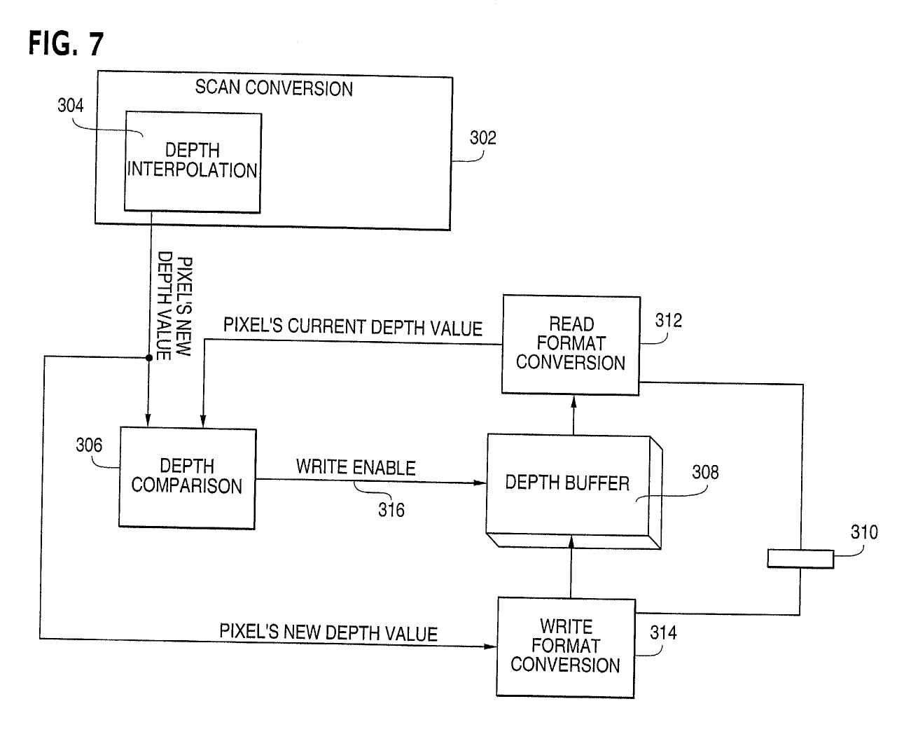

FIG. 7 is a block diagram showing features/functions relating to the depth test according to an example embodiment of the present invention. Other embodiments and configurations are also within the scope of the present invention. More specifically, FIG. 7 shows a scan conversion block 302 having a depth interpolation block 304. The depth interpolation block 304 within the scan conversion block 302 may compute the pixel's new Wfar/Wvalue via linear interpolation and then invert the Wfar/Wvalue to yield the pixel's new W/Wfar value. A pixel's new W/Wfar value may be forwarded to a depth test block 306 and a write format conversion block 314.

The read format conversion block 312 reads a particular pixel's current W/Wfar value from the depth buffer 308 and forwards it to the depth test block 306. Also, values read from the depth buffer 308 may be converted back to an appropriate value by the read format conversion block 312. That is, the read format conversion block 312 may convert the W/Wfar formatted value read from the depth buffer 308 into a value that may be used in the subsequent depth test. FIG. 7 additionally shows a register 310 to store a value corresponding to a number of fraction bits (or exponent bits) of the variable-formatable floating point number used in the depth buffer 308. The value stored within the register 310 may be used by the read format conversion block 312 to reformat the pixel's current W/Wfar value. The resulting value may then be forwarded from the read format conversion block 312 to the depth conversion block 306 for a subsequent comparison with the pixel's new W/Wfar value.

The depth test block 306 may perform a depth test of the pixel's current depth value and the pixel's new depth value. The result of the depth test may be forwarded to the depth buffer 308 as a write enable signal 316.

The write format conversion block 314 appropriately formats the pixel's new W/Wfar value to match the format used within the depth buffer 308 using the value stored within the register 310. The write format conversion block 314 then forwards the result to the depth buffer 308. The pixel's new, reformatted W/Wfar value may be stored in the depth buffer 308 depending on the write enable signal 316.

The value stored in the depth buffer (such as the depth buffer 308) may be a normalized W/Wfar value within a range of [0,1) as shown in FIG. 6. The software driver (such as within the processing unit 110) may perform a calculation to determine the number of exponent bits in the floating point number. By calculating the number of exponent bits, the software driver also effectively calculates the number of fraction bits. As one example, the number of exponent bits may be determined by the following equation:

WExponentSelect=clamp(floor[log2(log2(Wfar/Wnear))], 0, 8)

In this equation the ratio of Wfar/Wnear is computed. This is the inverse of the smallest value required to be represented in the depth buffer. Use of the inverse of the smallest value as the basis for the calculation is possible provided that the stored exponent is considered a negative number. This ratio may be then converted to an exponent of two using the log2 function. The number of bits to represent this exponent may then be computed using a second log2 function. As a number of exponent bits must be an integer, the floor function is used to remove any fractional value. Finally, the computed value is clamped to the range [0,8] given that the maximum number of exponent bits is 8, and the minimum number of exponent bits is 0.

Other equations and formulas are also within the scope of the present invention. The values of Wfar and Wnear are known to the software driver and may be fixed for each scene. As such, the software driver may determine or calculate the number of exponent bits and also the number of fraction bits (based on the total number of bits minus the number of exponent bits). The software driver may thereafter program the hardware (i.e., within the graphics device) based on the determination or calculation. The hardware may thereby map the values into the appropriate format. For example, the number of fraction bits (and/or the number of exponent bits) may be stored within a register. This stored value may be appropriately communicated to the graphics device to properly store and format values for the depth test. This allows a more optimal use of the total number of bits of storage provided for each pixel within a depth buffer. Each scene may use only one depth buffer for the whole scene. Accordingly, the exponent field is the same for the whole scene.

Increasing the number of exponent bits increases the precision of the values closer to zero at the expense of precision of values farther from zero (and closer to 1.0). Likewise, decreasing the number of exponent bits increases the precision of values farther from zero (closer to 1.0) at the expense of precision of values closer to zero. By examining the smallest value that needs to be represented (i.e., Wnear/Wfar), software may maximize the precision of W/Wfar values stored in the depth buffer by controlling the number of exponent bits used to represent them. The larger the ratio of Wnear/Wfar, the fewer the number of exponent bits are needed. If Wnear/Wfar is greater than 0.5, then a fixed point format may be used (i.e., the number of exponent bits from the above equation is zero).

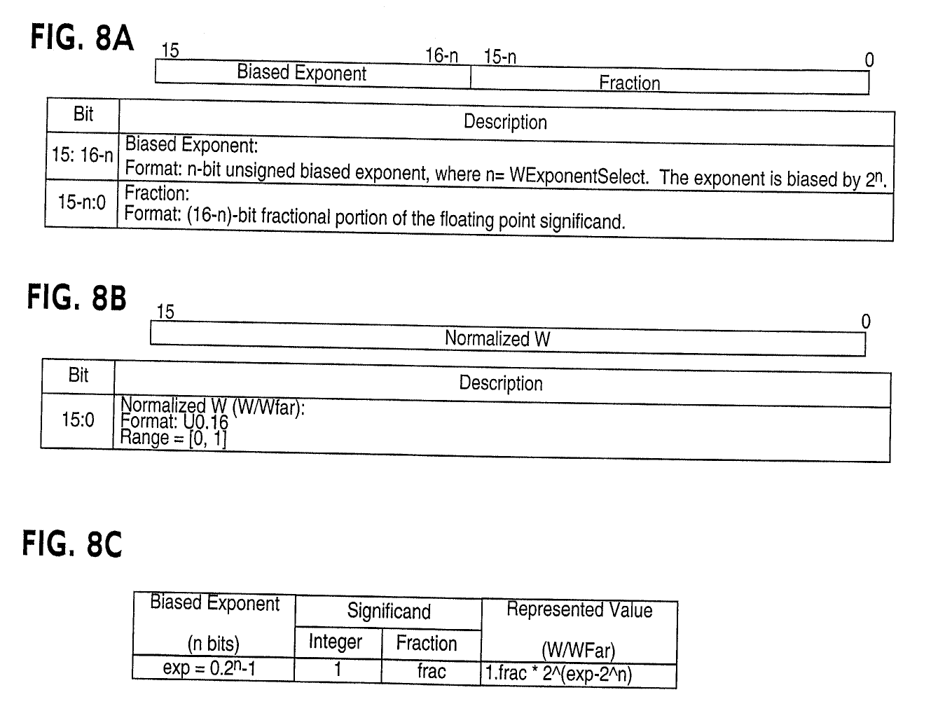

FIGS. 8A-8C illustrate formatting of a 16-bit floating point number, such as a 16-bit W depth buffer. The formatting of the floating point number may be done prior to the depth test comparison. That is, the formatting may be done prior to storing new pixel W/Wfar values in the depth buffer. As is well known, a floating point number has some number of fraction bits and some number of exponent bits. FIG. 8A illustrates that certain bits (i.e., bits 0 to 15-n) are fraction bits and certain bits (i.e., bits 16-n to 15) are exponent bits. Using the above described equation, the value of n (i.e., WExponentSelect) is calculated so as to determine the number of fraction bits. For example, if the value of WExponentSelect is calculated to be 9, then the bits 0 to 6 are fraction bits and the bits 7 to 15 are exponent bits. If the value of WExponentSelect is equal to zero, then the fixed format of FIG. 8B may be used where the normalized W (i.e., W/Wfar) may be stored as bits 0 to 15. FIG. 8C shows the real number represented by the stored value.

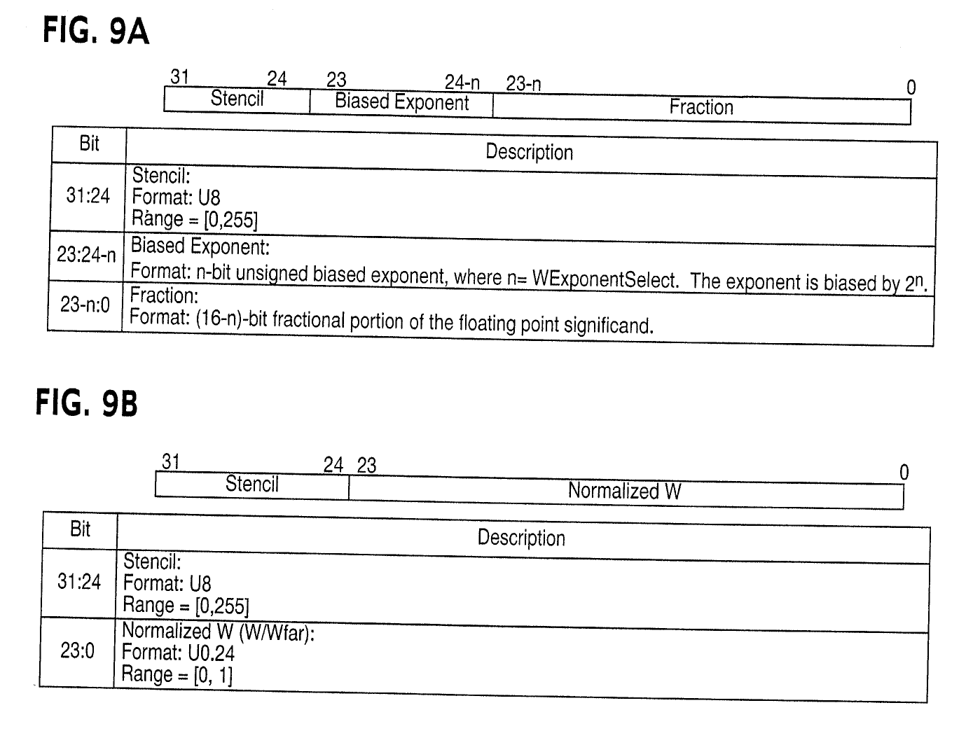

FIGS. 9A-9B illustrate formatting of a 32-bit floating point number, such as a W depth buffer having an 8-bit stencil value and a 24-bit floating point number. FIG. 9A illustrates that certain bits (i.e., bits 0 to 23-n) are fraction bits, certain bits (i.e., bits 24-n to 23) are exponent bits and bits 24 to 31 are stencil bits. Using the above described equation, the value of n (i.e., WExponentSelect) is calculated so as to determine the number of fraction bits. For example, if the value of WExponentSelect is calculated to be 9 then the bits 0 to 14 are fraction bits, the bits 15 to 23 are exponent bits and the bits 24 to 31 are stencil bits. If the value of WExponentSelect is equal to zero, then the fixed format of FIG. 9B may be used where the normalized W (i.e., W/Wfar) may be stored as bits 0 to 23 and the bits 24 to 31 are stencil bits.

As discussed above, the software driver may determine the appropriate number of fraction and exponent bits in the variable-formatable floating point number that will be stored in the depth buffer.

After determining the appropriate format such as by using the above described equation and by using the formatting of FIGS. 8 and 9, for example, the format of the depth buffer may be determined for a scene. As such, the depth test may be performed for each pixel using this format.

Embodiments of the present invention provide a method for performing a depth test for an image in a graphics system. This may include determining a format of a depth buffer device and storing a value associated with a pixel of the image in the depth buffer device based on the determined format of the depth buffer device. In the depth test, a value associated with a current pixel may be compared to the value stored in the depth buffer device in the determined format. More specifically, the depth test may involve a comparison of a W/Wfar value of the current pixel with a W/Wfar value of the corresponding pixel stored in the depth buffer device.

Any reference in this description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments.

Further, embodiments of the present invention or portions of embodiments may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, with respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc.

A machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other forms of propagated signals such as carrier waves, infrared signals, digital signals, etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A graphics system comprising:
a depth buffer device to store at least one variable-formatable floating point number relating to a depth of a pixel of an image; and
a first processing device to perform a depth test by comparing a value associated with a current pixel to a value associated with a corresponding pixel stored in said depth buffer device.

2. The system of claim 1, wherein said depth buffer device stores at least a value relating to a W value of each pixel of said image.

3. The system of claim 1, further comprising a second processing device to calculate a number of fraction bits of said variable-formatable floating point number.

4. The system of claim 3, further comprising at least one register to store the calculated number of fraction bits.

5. The system of claim 1, wherein said first processing device compares a W/Wfar value of said current pixel with a W/Wfar value of the corresponding pixel stored in said depth buffer device.

6. The system of claim 1, further comprising a display device to display an image based on a result of said depth test.

7. A system comprising:
a depth buffer device to store at least a value relating to a pixel of an image; and
a processing device to determine a format of said value stored in said depth buffer device and to perform a depth test for pixels in said image based on values stored within said depth buffer device.

8. The system of claim 7, wherein said depth buffer device stores at least a value relating to a W value of each pixel.

9. The system of claim 7, wherein said value comprises a floating point number.

10. The system of claim 9, wherein said floating point number comprises a variable-formatable floating point number.

11. The system of claim 7, wherein said processing device calculates a number of fraction bits of said floating point number.

12. The system of claim 11, further comprising at least one register to store the calculated number of fraction bits.

13. The system of claim 7, wherein said processing device compares a W/Wfar value of a current pixel with a W/Wfar value of the corresponding pixel stored in said depth buffer device.

14. The system of claim 7, further comprising a display device to display an image based on a result of said depth test.

15. A method comprising:
determining a format of a depth buffer device;
storing a value associated with a pixel of an image in said depth buffer device based on the determined format of said depth buffer device; and
comparing a value associated with a current pixel to said value stored in said depth buffer device in said determined format.

16. The method of claim 15, wherein determining said format comprises calculating a number of fraction bits of a floating point number.

17. The method of claim 16, further comprising storing said calculated number of fraction bits in a register.

18. The method of claim 17, wherein said stored value is based on said calculated number of fraction bits stored in said register.

19. The method of claim 15, further comprising displaying an image based on said comparison.

20. The method of claim 15, wherein said stored value in said depth buffer device relates to a W value of each pixel.

21. The method of claim 15, wherein said comparing comprises comparing a W/Wfar value of said current pixel with a W/Wfar value of the corresponding pixel stored in said depth buffer device.

22. A method of performing a depth test for an image, said method comprising:
calculating a number of fraction bits for a depth buffer device; and
storing a value of a current pixel in said depth buffer device in a format based on said calculated number of fraction bits.

23. The method of claim 22, further comprising performing said depth test by comparing a value associated with said current pixel to said value associated with a corresponding pixel stored in said depth buffer device.

24. The method of claim 23, further comprising displaying said image based on said depth test.

25. The method of claim 23, wherein said comparing comprises comparing a W/Wfar value of said current pixel with a W/Wfar value of the corresponding pixel stored in said depth buffer device.

26. The method of claim 22, wherein said stored value in said depth buffer device relates to a W value of one pixel of said image.

27. A program storage device readable by machine, tangibly embodying a program of instructions executable by the machine to perform a method comprising:
determining a format of a depth buffer device; and
storing a value of said determined format.

28. The program storage device of claim 27, wherein said method further comprises:
storing a value associated with a pixel of an image in said depth buffer device based on the determined format of said depth buffer device; and
comparing a value associated with a current pixel to said value stored in said depth buffer device in said determined format.

29. The program storage device of claim 27, wherein determining said format comprises calculating a number of fraction bits of a floating point number.

30. The program storage device of claim 29, wherein said stored value is based on said calculated number of fraction bits.
